(19) United States
(12) Patent Application Publication
(10) Pub. No.: US 2026/0042255 A1
(43) Pub. Date: Feb. 12, 2026

(54) DYNAMIC CONTROL OF MICROSTRUCTURES DURING EXTRUSION

(71) Applicant: Board of Regents, The University of Texas System, Austin, TX (US)

(72) Inventors: Joshua Taylor Green, El Paso, TX (US); Joseph William McKee, El Paso, TX (US); Ian Andrew Rybak, El Paso, TX (US)

(21) Appl. No.: 19/293,710

(22) Filed: Aug. 7, 2025

Related U.S. Application Data
(60) Provisional application No. 63/680,858, filed on Aug. 8, 2024.

(51) Int. Cl. B29C 64/209; B29C 48/00; B29C 48/02; B29C 48/30; B29C 64/118; B29C 64/336; B29C 64/386; B33Y 40/00; B33Y 50/00

(52) U.S. Cl. CPC B29C 64/209; B29C 48/02; B29C 48/022; B29C 48/301; B29C 64/118; B29C 64/336; B29C 64/386; B33Y 40/00; B33Y 50/00

(57) ABSTRACT

An apparatus for additive manufacturing. The apparatus comprises a hotend for heating filaments for a number of materials and a nozzle coupled to the hotend. The nozzle is configured to extrude the filaments for the number of materials onto a build surface, and at least one of components of the apparatus is configured to rotate during extrusion of the filaments for the number of materials to mix the filaments for the number of materials according to a print plan. The print plan defines locations and proportions of the number of materials in the extrusion of the filaments.

### CROSS-REFERENCE TO RELATED PROVISIONAL APPLICATION

This application claims the benefit of U.S. Provisional Patent Application Ser. No. 63/680,858, filed Aug. 8, 2024, and entitled “Dynamic Control of Microstructures during Extrusion.”

### BACKGROUND INFORMATION

### 1. Field

The present disclosure relates to additive manufacturing and in particular to methods and devices for dynamic control of microstructures during extrusion.

### 2. Background

Additive manufacturing refers to technologies that build three-dimensional objects layer by layer from digital models or has non-planar layup and may derive the print from prescribed printer objectives. Unlike traditional manufacturing methods that remove material through cutting or shaping, additive manufacturing works by adding material only where it is needed. This approach enables creation of complex geometries, internal structures, and customized designs that would be difficult or impossible to achieve with conventional manufacturing techniques.

Additive manufacturing utilizes a wide range of materials such as thermoplastics, photopolymers, metals, ceramics, and composites. Nowadays, additive manufacturing is commonly used in variety of industries such as aerospace, automotive, biomedical engineering, and tooling.

### SUMMARY

An illustrative embodiment provides an apparatus for additive manufacturing. The apparatus comprises a hotend for heating filaments for a number of materials; and a nozzle coupled to the hotend, wherein the nozzle is configured to extrude the filaments for the number of materials onto a build surface, and wherein at least one of components of the apparatus is configured to rotate during extrusion of the filaments for the number of materials to mix the filaments for the number of materials according to a print plan, and wherein the print plan defines locations and proportions of the number of materials in the extrusion of the filaments.

Another illustrative embodiment provides an apparatus for additive manufacturing. The apparatus comprises a hotend for heating filaments for a number of materials; a rod coupled to and positioned within the hotend, wherein the rod comprises a number of inlets positioned on the rod in a circular manner, and wherein the number of inlets are activated in a sequential manner to control mixing of filaments for the number of materials according to a print plan, and wherein the print plan defines locations and proportions of the number of materials in the extrusion of the filaments; and a nozzle coupled to the hotend, wherein the nozzle is configured to extrude the filaments for the number of materials onto a build surface.

Another illustrative embodiment provides a method of additive manufacturing. The apparatus comprises a hotend for heating filaments for a number of materials; a number of inlets positioned in the apparatus, and wherein the number of inlets are activated in a sequential manner to control mixing of filaments for the number of materials according to a print plan, and wherein the print plan defines locations and proportions of the number of materials in the extrusion of the filaments; and a nozzle coupled to the hotend, wherein the nozzle is configured to extrude the filaments for the number of materials onto a build surface.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a 3D printer system in accordance with an illustrative embodiment;

FIG. 2 is diagram of side view for an extrusion in accordance with an illustrative embodiment;

FIG. 3 depicts cross sections of an extrudate in accordance with an illustrative embodiment;

FIG. 4 illustrates a number of exemplary microstructural configurations in accordance with an illustrative embodiment;

FIGS. 5A-5B illustrate an additive manufacturing apparatus in accordance with an illustrative embodiment;

FIG. 6 illustrates front views and cross section views of inlets and outlets in accordance with an illustrative embodiment;

FIGS. 7A-7F illustrate an additive manufacturing apparatus that contains a hotend or toolhead with a rod in accordance with an illustrative embodiment; and

FIGS. 8A-8D illustrate front view and sectional views of a rod used in a hotend in accordance with an illustrative embodiment.

### DETAILED DESCRIPTION

The illustrative embodiments recognize and take into account one or more considerations. For example, the illustrative embodiments recognize and take into account that distributions of material phases and reinforcement materials can be advantageous for a variety of material functions and printing processes.

The illustrative embodiments also recognize and take into account that conventional methods for multimaterial printing and local composition control can vary the composition of extrudate. In other words, control of features within an extrusion is minimal and rather control of the composition is usually dependent upon the input material and the print plan which varies features such as temperature and toolpath.

The illustrative embodiments also recognize and take into account that variations in composition can benefit the printability and post-processing of the materials. Material distribution can support advanced adhesion, reduced warping, increased strength, and processibility. In this case, it can extend to an expansion in compatible materials for the corresponding manufacturing process as material distribution improves the manufacturing process.

Thus, the illustrative embodiments provide an apparatus for additive manufacturing that comprises a hotend for heating filaments for a number of materials, and a nozzle coupled to the hotend, wherein the nozzle is configured to extrude the filaments for the number of materials onto a build surface. In addition, at least one of components of the apparatus is configured to rotate during extrusion of the filaments for the number of materials to mix the filaments for the number of materials according to a print plan. Further, the print plan defines locations and proportions of the number of materials in the extrusion of the filaments.

In addition, the illustrative embodiments provide an apparatus for additive manufacturing that includes a hotend for heating filaments for a number of materials; a rod coupled to and positioned within the hotend, wherein the rod comprises a number of inlets positioned on the rod in a circular manner, and wherein the number of inlets are activated in a sequential manner to control mixing of filaments for the number of materials according to a print plan, and wherein the print plan defines locations and proportions of the number of materials in the extrusion of the filaments; and a nozzle coupled to the hotend, wherein the nozzle is configured to extrude the filaments for the number of materials onto a build surface.

Certain terms are used throughout the following description and claims to refer to particular device components and configurations. As one skilled in the art will appreciate, the same component may be referred to by different names. This document does not intend to distinguish between components that differ in name but not function.

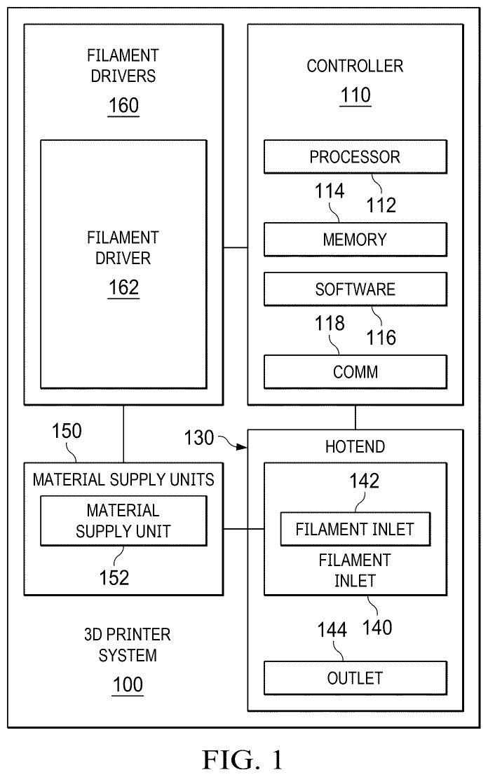

With reference now to the figures and, in particular, with reference to FIG. 1, a block diagram of a 3D printer system 100 is depicted in accordance with an illustrative embodiment. 3D printer system 100 includes at least a controller 110, material supply units 150, and a hotend 130. In this illustrative example, 3D printer system 100 can be an example of an apparatus for additive manufacturing.

In this illustrative example, controller 110 prepares a print plan that includes digital data which characterizes a 3-D object for printing. In this illustrative example, the print plan defines locations and proportions of materials in the extrusion of the filament. In other words, the print plan can be utilized to locally control composition distribution throughout the local cross sections of the extrusions made using the filaments for materials.

In this example, controller 110 controls the operation of the apparatus for additive manufacturing and can include, for example, a processor 112, a memory unit 114, software code 116, and a communications unit 118.

Controller 110 can be located inside 3D printer system 100 or outside of 3D printer system 100 and communicate with 3D printer system 100 over a wire and/or using wireless communications. Control functionality might be spread across units, and not all control functionality may be within 3D printer system 100. For example, a separate unit, such as a personal computer or workstation, or a processing unit within a supply source such as a cartridge may provide some control or data storage capability.

Communications unit 118 enables transfer of data and instructions between controller 110 and hotend 130, between controller 110 and material supply units 150 and between controller 110 and other system elements. Controller 110 can be coupled and connected to various components of 3D printer system 100.

Controller 110 can utilize Computer Object Data (COD) representing an object or a model such as CAD data in STL format. Controller 110 converts such data to instructions for the various units within 3D printer system 100 to print a 3D object. In this illustrative example, it should be understood that other types of data or data formats can also be used by 3D printer system 100 to print a 3D object.

Controller 110 can be implemented using any suitable combination of hardware and software. In this illustrative example, controller 110 can include processor 112, memory 114, and software 116. Processor 112 can include conventional devices, such as a Central Processing Unit (CPU), a microprocessor, a “computer on a chip”, a micro controller, etc. Memory 114 can include conventional devices such as Random Access Memory (RAM), Read-Only Memory (ROM), or other storage devices, and may include mass storage, such as a CD-ROM or a hard disk.

Material supply units 150 supply building materials to hotend 130. Building materials can include any suitable kind of object building material. For example, the building materials can include photopolymers, wax, powders, plastics, metals, modeling material, support material, release material, or any alternative material types or combinations of material types. In this illustrative example, the building materials used for construction of the 3D object can be in a liquid form.

In this illustrative example, the modeling materials and support materials can include photopolymers that may contain material curable by electro-magnetic radiation or electron beams.

In this example, each material supply unit such as material supply unit 152 in material supply units 150 can supply a separate material to a corresponding filament inlet 142 among filament inlets 140 in hotend 130. In this illustrative example, filament inlets 140 are functional parts or pathways that allow a specific input such as material to enter components of 3D printer system 100. For example, filament inlets 140 can be a place where the filament of material is introduced to the extruder of 3D printer system 100. In some illustrative examples, filament inlets 140 can be where the powder of material is deposited onto the building platform.

In addition, filament driver 162 controls the flow of material from material supply units 150 to filament inlets 140, with a separate driver for each supply unit. For example, filament driver 162 can control flow of material from material supply unit 152. In some illustrative examples, at least one of the materials supplied by a material supply unit 152 from material supply units 150 to the filament inlets 140 is heterogeneous to materials supplied by the other material supply units from material supply units 150.

The building material from the filament inlets enters a hotend 130, where they are blended together and extruded through outlet 144. In this example, outlet 144 is a component through which material exits 3D printer system 100 during or after the printing process. In other words, outlet 144 serves as exit points for melted filament of materials during the printing process. For example, outlet 144 in 3D printer system 100 can be a nozzle that can also be used for controlling flow, direction, and shape of the extruded materials.

As depicted, distributions of material phases and reinforcement materials can be advantageous for a variety of material functions and printing processes. Material interfaces and surfaces commonly have different composition or reinforcement density to facilitate properties such as corrosion resistance, solubility, wear resistance, variations in emissivity, hardness, color, electrical conductivity, heat transfer, adhesion, and more. Such features support many functions and applications such as load distribution in gears, visual appearance, electrostatic discharge in electronics, surface finish facilitated through solubility in support structures, and more. Internal variations in composition commonly have different composition of reinforcement density to facilitate properties such as toughness, thermal expansion coefficients, stiffness, strength, and more. Such features support many functions and applications such as load ratings in structural components, minimized crack growth from thermal cycling in heat engines, and more. Some of these features are sensitive to size and location. Therefore, control over the size of these features, the microstructural distribution, and location of these features is critical to their function.

In addition, variations in composition may benefit the printability and post-processing of the materials. Efforts have been made to vary composition within filaments providing a core of one material and a shell of another material. In this illustrative example, material distribution can support advanced adhesion, reduced warping, increased strength, processibility, and more.

As material distribution may improve the manufacturing process, it may extend to an expansion in compatible materials for the corresponding manufacturing process. For example, materials that are favored for function may not be printable in certain scenarios. This dilemma can be resolved using a technique that facilitates printing by combining materials that are low in printability with materials that are high in printability. In effect, features like surfaces could be composed of materials which are not printable on their own while the rest of the structure is made of printable materials.

In this illustrative example, 3D printer system 100 can be configured to have at least one of components of 3D printer system 100 rotating during extrusion of the filaments for materials to mix the materials according to a print plan.

In this example, the print plan can define locations and proportions of the materials in the extrusion of the filaments. In other words, the print plan is utilized by controller 110 to locally control a composition profile of extrusions made using filaments of the materials to achieve microstructural control of extrusions. In this example, the print plan can be used to generate a set of program instructions for software 116 for rotating the at least one of the components of 3D printer system 100.

For example, 3D printer system 100 can be configured to rotate hotend 130, filament inlets 140, outlet 144, a mixing rod, a nozzle, or any suitable components of 3D printer system 100 such that filaments for materials supplied by material supply units 150 can be mixed during extrusion to achieve microstructural control according to a print plan.

In an alternative example, 3D printer system 100 can be configured to achieve microstructural controls entirely based on the print plan. For example, filament inlets 140 from 3D printer system 100 can be arranged in a circular manner and activated in a sequential manner to mix filaments of the materials according to the print plan.

In this illustrative example, materials supplied by material supply units 150 can include materials with different temperatures during the manufacturing process, materials of different colors or appearances, materials of different compositions, or any suitable combination of materials. In addition, materials supplied by material supply units 150 can also include catalysts that promote crystallization of melted polymers from the filaments for materials supplied by material supply units 150.

In this illustrative example, the print plan can be generated or designed based on a number of variables or parameters for operating components of 3D printer system 100. For example, the print plan can be generated based on internal flow mechanics such as no-slip condition, volume of the melt chamber, melt chamber geometry, mixing rod geometry, and rate of deformation such as a rate of mixing rod relative to the static hotend wall from hotend 130, material properties such as viscosity and compressibility, print parameters such as temperature, extrusion deposit flow such as internal stress, pressure, environment geometry, extrusion aspect ratio for additive manufacturing using the filaments for the number of materials, and any suitable parameters that are expected to influence microstructure control of extrusion from 3D printer system 100.

In this example, the print parameters can further include a component ratio that defines component rotation or rate of rotation relative to the rate of extrusion, a filament ratio that defines proportion of filament extrusion rates through filament inlets 140 relative to the extrusion rate through outlet 144, steady and unsteady flow conditions, predicted filament flow through the hotend 130 using a number of machine learning models, an extrusion aspect ratio that defines height and width of the extrusion, and shapes of extrusions such as triangle, circle, oval, or any complex shapes.

In this illustrative example, 3D printer system 100 can facilitate control of microstructural characteristics within extrusions including shape, location, and proportion. For example, control of these features during additive manufacturing is controlled by dynamically modifying filament mix ratios and active-mixing rod rotation. In this example, the mixing rod rotation is set to control the streamlines of the incoming materials such that they exit the toolhead at locations to generate the desired phase distribution in the microstructure to provide control of the microstructure within the extrusion.

In this illustrative example, 3D printer system 100 is configured so that it can vary the output in different material phases. This can be achieved by using software 116 from controller 110 to support control functions and utilizing a combination of filament inlets 140 and outlet 144, features to control port locations or exit orifice shape, control over geometric features within the toolhead or at outlet 144, which alter the flow properties within the toolhead, reorientation of the toolhead during printing, and varying rates of material flow.

The illustration of 3D printer system 100 in FIG. 1 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, 3D printer system 100 can include multiple outlets for outputting extrusion from 3D printer system 100.

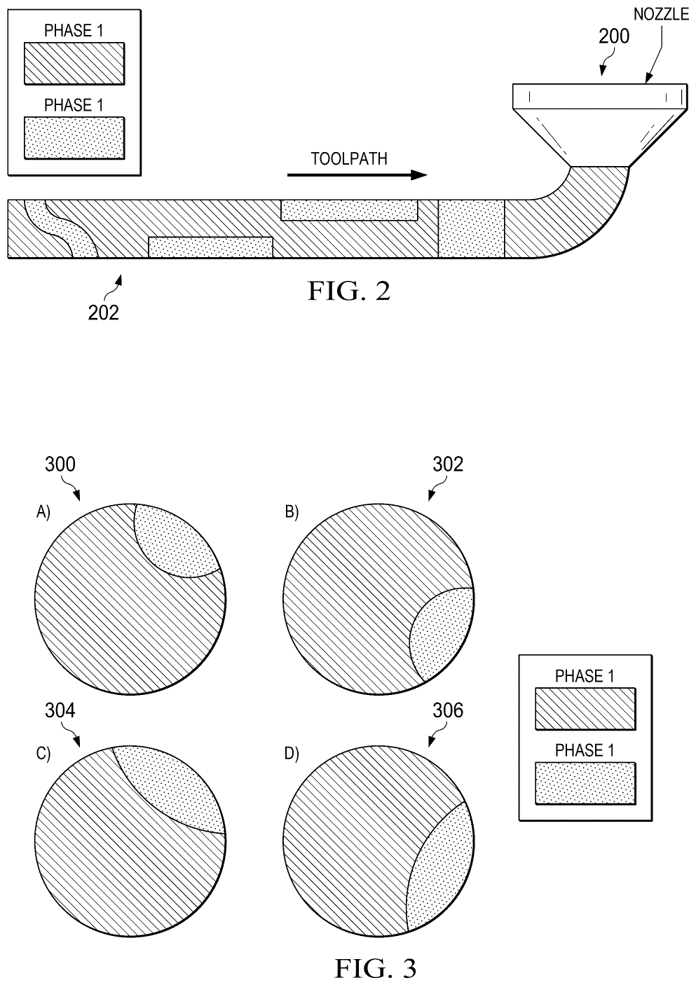

FIG. 2 is diagram of side view for an extrusion in accordance with an illustrative embodiment. In this example, nozzle 200 can be an example of outlet 144 from 3D printer system 100 in FIG. 1. In this illustrative example, nozzle 200 can be configured to include a plurality of outlets with different shapes.

In this illustrative example, extrudate 202 includes two material phases that are extruded from nozzle 200. In this example, the phase distribution for two materials included in extrudate 202 can be achieved by mixing filaments of the two materials according to a print plan using an additive manufacturing device with at least one rotatable component such as 3D printer system 100 from FIG. 1.

In this illustrative example, extrudate 202 shows microstructural control along a toolpath as illustration of spatial control of phase distribution of the two materials. As depicted, distribution of the two material phases from extrudate 202 can be configured in any shape, size, or orientations. In other words, the distribution of materials within an extrusion during additive manufacturing can be dynamically varied to achieve microstructural control. In this illustrative example, any number of materials and material phases can be controlled within the extrusion. Materials and material phases can be distributed throughout the extrusion in any fashion. Unlike existing methods, variation in distribution can be controlled in both shape and proportion.

The illustration of extrudate 202 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, extrudate 202 from nozzle 200 can have a different distribution of material phases with different shapes, sizes, or orientations according to a different print plan.

FIG. 3 depicts cross sections of an extrudate in accordance with an illustrative embodiment. In this illustrative embodiment, cross section 300, cross section 302, cross section 304, and cross section 306 can be examples of cross sections of extrudate 202 from FIG. 2.

In FIG. 3, cross section 300, cross section 302, cross section 304, and cross section 306 show extrusion microstructures composed of two material phases. In this example, the material phases from cross section 300, cross section 302, cross section 304, and cross section 306 can occupy any part of the extrusion and in any proportion. For example, cross section 300 has a small region of material phase 2 located at the top right of the extrusion while cross section 302 has a small region of material phase 2 located at the bottom right of the extrusion. In addition, cross section 304 has a larger region of material phase 2 located at the top right of the extrusion while cross section 306 has a large region of material phase 2 located at the bottom right of the extrusion. In this illustrative example, phase distributions in cross section 300, cross section 302, cross section 304, and cross section 306 can be achieved by mixing filaments of materials using an additive manufacturing device such as 3D printer system 100 in FIG. 1 according to a print plan.

The illustration of cross sections in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, extrudate 202 from nozzle 200 can have a different distribution of material phases with different shapes, sizes, or orientations according to a different print plan. For example, cross section 300, cross section 302, cross section 304, and cross section 306 can have any number of phases, materials, crystal structures and orientations, and reinforcement density.

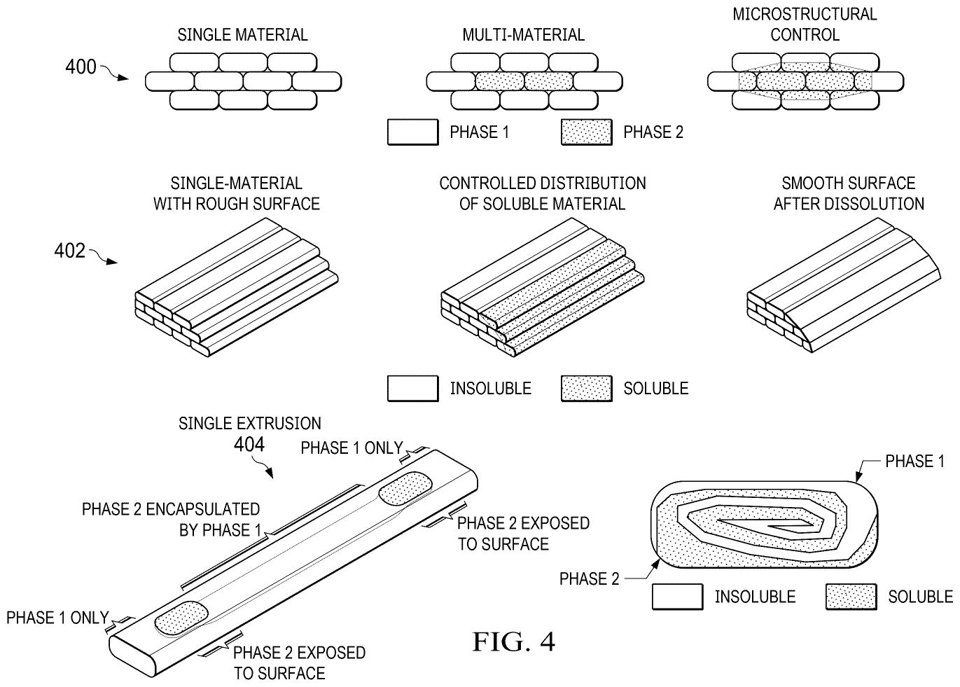

FIG. 4 illustrates a number of exemplary microstructural configurations in accordance with an illustrative embodiment. In this illustrative example, the microstructural configurations shown in FIG. 4 can be achieved based on a print plan using an additive manufacturing device with at least one rotatable component such as 3D printer system 100 from FIG. 1.

In this illustrative example, illustration 400 shows structure with a coating of phase 1 to the exterior of the extrudate while making the interior of the extrudate using a different material. In this illustrative example, illustration 400 can show a structure for corrosion resistance. For example, illustration 400 can show a structure with the phase 1 material being corrosion resistant. In this example, printability or structural properties can be supported through multimaterial or microstructural control using the phase 2 materials shown in illustration 400.

In addition, illustration 402 shows a stair stepping surface finish when a single material can be improved through microstructural control with soluble materials at the surface.

Furthermore, illustration 404 shows selective exposure of the phase 2 material to the surface of a single extrusion. As depicted in illustration 404, the structure can be printed with most of phase 2 material being encapsulated by phase 1 material while a small amount of phase 2 material is exposed to the surface. Moreover, illustration 406 illustrates a complex microstructure which greatly increases the area of the interface between the two phases of materials.

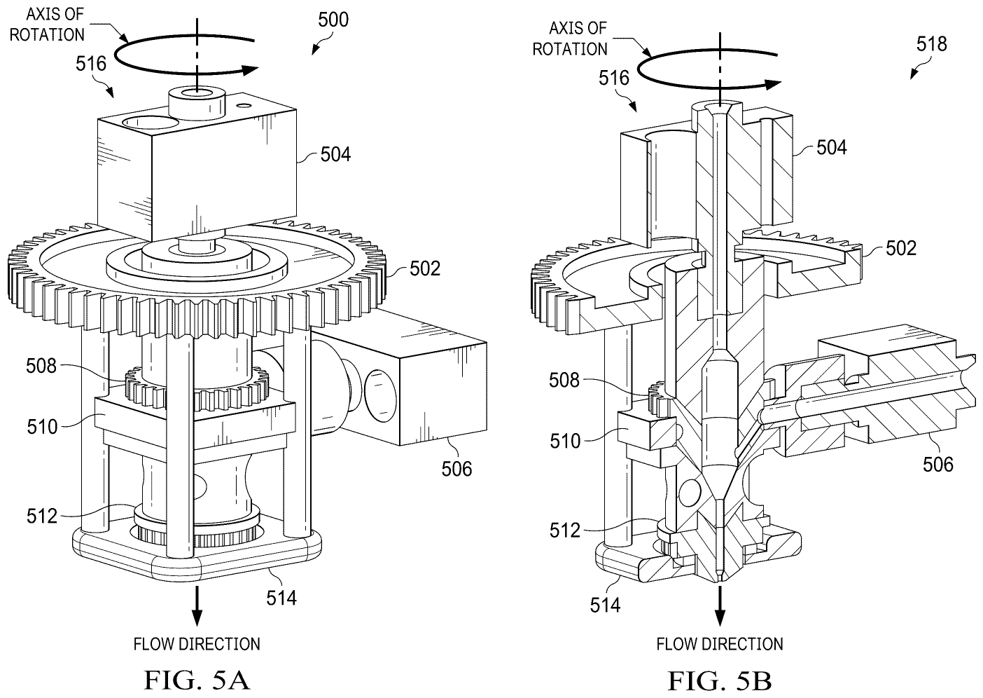

FIG. 5A-5B illustrates an additive manufacturing apparatus in accordance with an illustrative embodiment. In this illustrative example, additive manufacturing apparatus 516 shown in front view 500 and cross section view 518 can be an example of 3D printer system 100 or at least a portion of 3D printer system 100 in FIG. 1.

In this illustrative example, additive manufacturing apparatus 516 includes various components. For example, additive manufacturing apparatus 516 includes inlet 504 and inlet 506. In this example, inlet 504 and inlet 506 can be temperature controlled inlets such that filaments of different materials fed by inlet 504 and inlet 506 can have different temperatures during the manufacturing process.

In this example, inlet 504 is an inlet that feeds filament of material from the top of additive manufacturing apparatus 516 while inlet 506 is an inlet that feeds filament of material from the side of additive manufacturing apparatus 516.

In this illustrative example, additive manufacturing apparatus 516 further includes outlet 514 that outputs mixed filaments from additive manufacturing apparatus 516. In this illustrative example, additive manufacturing apparatus 516 receives filaments of materials from inlet 504 and inlet 506, mixing the filaments of materials according to a print plan, and output of the mixed filaments of materials from outlet 514 following the flow direction as illustrated in front view 500 and cross section view 518.

In this example, at least one component of additive manufacturing apparatus 516 is configured to rotate along the axis of rotation as illustrated in front view 500 and cross section view 518. For example, housing 502 can be configured to rotate such that the entire toolhead of additive manufacturing apparatus 516 can rotate to mix filaments of materials supplied by inlet 504 and inlet 506 according to a print plan.

In an alternative illustrative example, outlet 514 can include rotatable nozzle 512 that is configured to rotate using the gear design on a nozzle such that outlet 514 can rotate to mix filaments of materials supplied by inlet 504 and inlet 506 according to a print plan.

In yet another alternative illustrative example, inlet 506 can be configured to include rotatable portion 508 and static portion 510. In this illustrative example, static portion 510 attaches inlet 506 to housing 502 such that inlet 510 is fixed in position when feeding filaments of materials to additive manufacturing apparatus 516. In this example, rotatable portion 508 has a similar structure compared to rotatable nozzle 512. In other words, rotatable portion 508 is configured to rotate using the gear design on rotatable portion 508. In this example, rotatable portion 508 can have a flow channel and inlet that guides filaments of materials supplied by inlet 506 to the appropriate location within additive manufacturing apparatus 516 for mixing.

The illustration of additive manufacturing apparatus 516 in FIG. 5 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, other components of additive manufacturing apparatus 516 can be configured to rotate such that filaments of materials can be mixed according to a print plan to achieve microstructure control of compositions in extrudate from additive manufacturing apparatus 516.

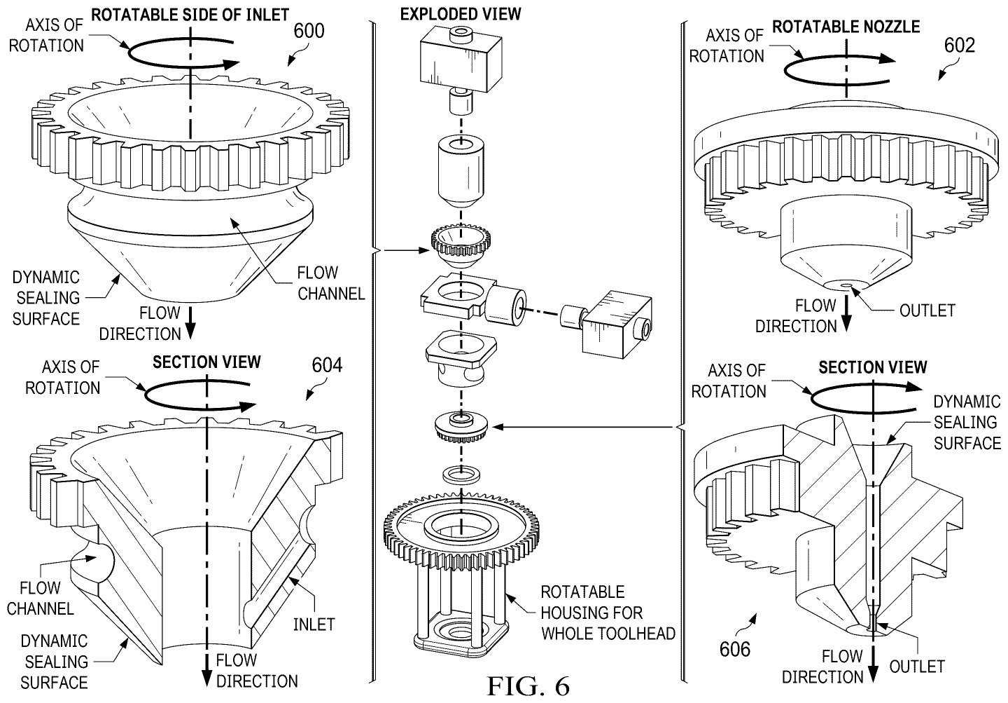

FIG. 6 illustrates front views and cross section views of inlets and outlets in accordance with an illustrative embodiment. In this illustrative example, a rotatable portion of inlet shown in front view 600 and cross section view 604 can be an example of rotatable portion 508 in FIG. 5. In addition, a rotatable portion of outlet shown in front view 602 and cross section view 606 can be an example of rotatable nozzle 512 in FIG. 5.

In this example, FIG. 6 shows additive manufacturing apparatus 516 in an exploded view. As depicted, rotatable portion of inlet shown in front view 600 and cross section view 604 can be configured to rotate along the axis of rotation to mix filaments of materials fed from flow channel and inlet from the rotatable portion of inlet shown in front view 600 and cross section view 604.

In this illustrative example, the rotatable portion of inlet shown in front view 600 and cross section view 604 can include a dynamic sealing surface to eliminate leaking of filaments between different components in the additive manufacturing apparatus 516.

In this example, filaments of materials follow inlet and flow channel on the rotatable portion of inlet to the center of the rotatable portion for mixing them with other filaments of materials. After the mixing, mixed filaments exit to other components of the additive manufacturing apparatus 516 by following flow direction shown in front view 600 and cross section view 604.

In addition, the rotatable nozzle of outlet shown in front view 602 and cross section view 606 can also be configured to rotate along the axis of rotation to mix filaments of materials fed from inlets of the additive manufacturing apparatus 516. In a similar fashion, the rotatable nozzle of outlet shown in front view 602 and cross section view 606 can include dynamic sealing surface to eliminate leaking of filaments between different components in the additive manufacturing apparatus.

In this example, filaments of materials enter the rotatable nozzle shown in front view 602 and cross section view 606 front view 602 and cross section view 606 from top and follows the flow direction to the outlet such that the mixed filaments of materials can be output from the outlet.

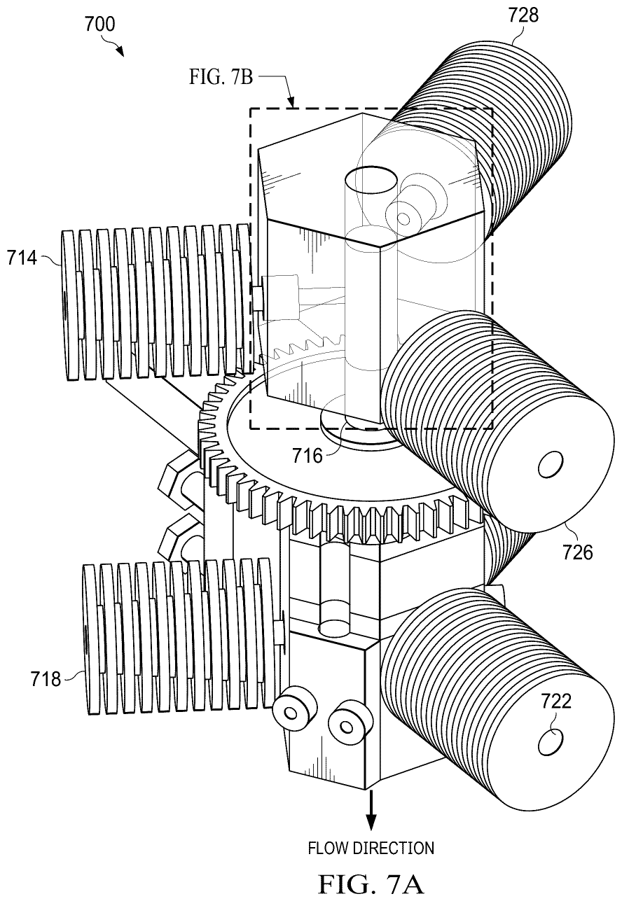

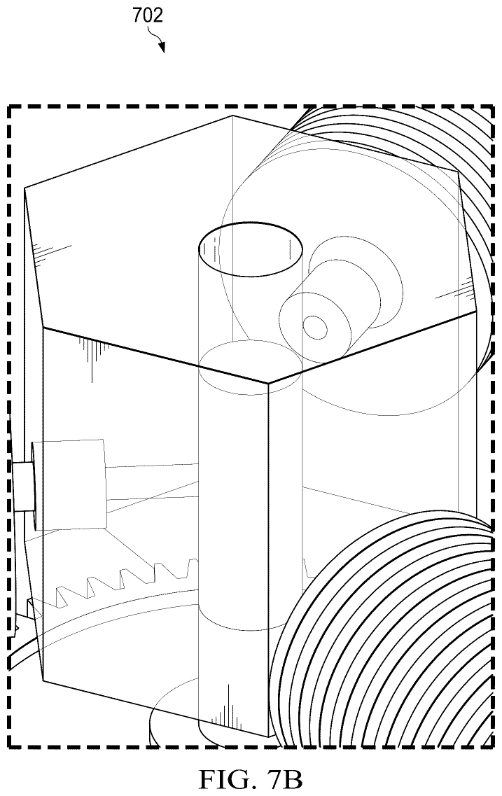

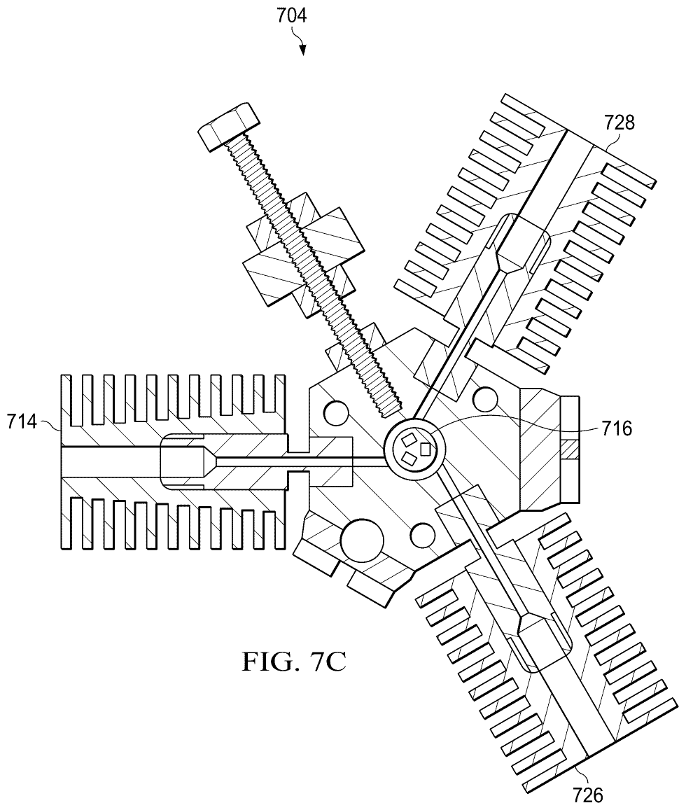

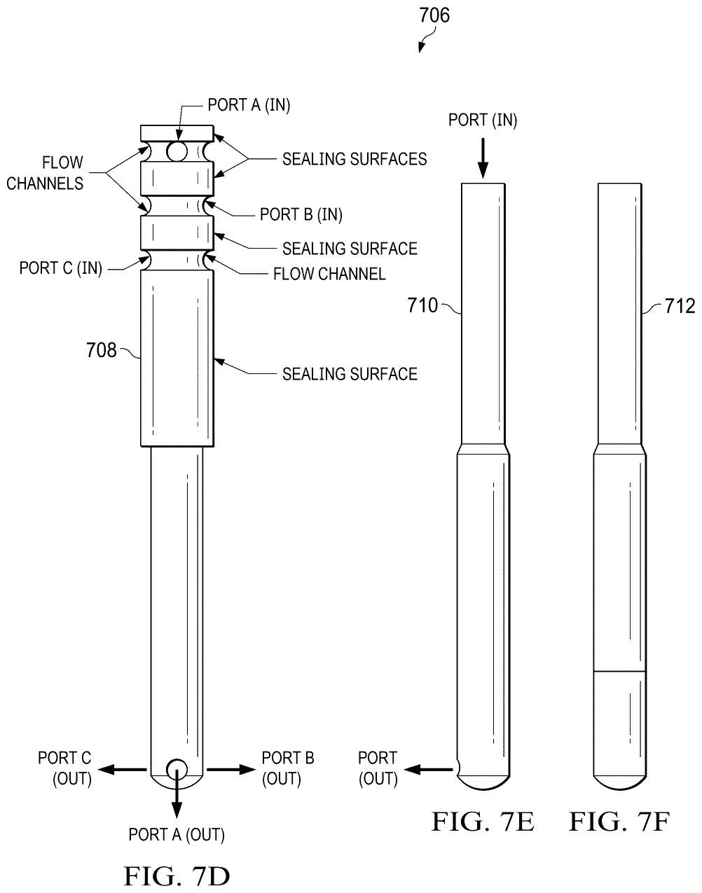

FIG. 7 illustrates an additive manufacturing apparatus that contains hotend or toolhead with a rod in accordance with an illustrative embodiment. In this illustrative example, hotend 700 can be an example of hotend 130 in FIG. 1.

In FIG. 7A-7F, hotend 700 includes rotatable rod 716 that is configured to rotate to mix filaments of materials received from inlet 714, inlet 726, and inlet 728. In this illustrative example, rotatable rod 716 has three different flow channels and three different ports for connecting inlet 714, inlet 726, and inlet 728, as illustrated as different grooves on rotatable rod 716 in hotend 700 and detail view 702 illustrated in FIG. 7B.

In this illustrative example, hotend 700 can further include inlet 718 and inlet 722 for inputting filaments of materials to hotend 700.

In this illustrative example, inlet 714, inlet 726, and inlet 728 are placed at different heights along rotatable rod 716. In other words, filaments of materials enter hotend 700 along flow channels of rotatable rod 716 located at different heights of rotatable rod 716.

For example, inlet 728 is connected to flow channel of port A on rotatable rod 716, as illustrated as the top grooves in hotend 700 and detail view 702. In addition, inlet 714 is connected to flow channel of port B on rotatable rod 716, as illustrated as the middle grooves in hotend 700 and detail view 702. Further, inlet 726 is connected to flow channel of port C on rotatable rod 716, as illustrated as the bottom grooves in hotend 700 and detail view 702.

In FIG. 7C, cross section 704 depicts a top sectional view of hotend 700 with rotatable rod 716 in accordance with an illustrative embodiment. Cross section 704 is a top view providing details of the hotend 700 configured for mixing filament of materials from inlet 714, inlet 726, and inlet 728 according to a print plan to achieve microstructure control.

Cross section 704 further illustrates three different channels connected to inlet 714, inlet 726, and inlet 728. Filaments travel from inlet 714, inlet 726, and inlet 728 and through the three different channels, as illustrated in cross section 704.

In FIG. 7DD, rods 706 depict exemplary rods that can be implemented in hotend 700. In this example, rod 708 is identical to rod 716 in configuration and designs. As depicted, rod 708 has three different flow channels connected with port A, port B, and port C respectively at different heights located on rod 708. In this illustrative example, the flow channels and ports of rod 708 are separated by sealing surfaces to eliminate leaking of filaments of materials between different flow channels and ports. In this example, the filaments of materials enter port A, port B, and port C via flow channels and flow along rod 716 and exit the ports at the bottom of rod 716, as illustrated on rod 716 in FIG. 7.

It should be noted that rod 716 can be implemented with other designs even though rod 716 in hotend 700 is configured using same design as rod 708. or example, rod 716 can also be implemented using designs for rod 710 and rod 712 as illustrated in FIG. 7E and FIG. 7F. In this example, rod 710 is configured to have one port that receives filaments of materials from the top and one port at the bottom of rod 710, where filaments of materials exit. In addition, rod 712 shows an implementation of rod 716 that has no ports or flow channels on it. In this example, filaments of materials can enter hotend 700 via other inlets and rod 712 is only configured for rotation purposes.

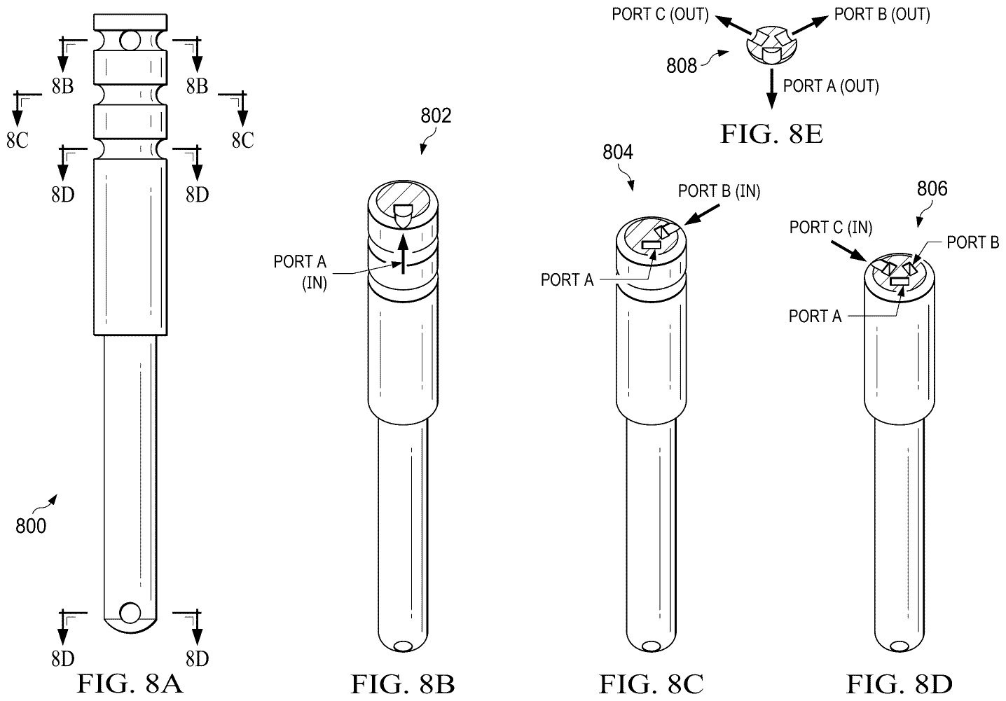

FIG. 8A-8D depicts front view and sectional views of a rod used in a hotend in accordance with an illustrative embodiment. In this illustrative example, the rod and portions of the rod shown in front view 800, section view 802, section view 804, section view 806, and section view 808 can be examples of rods or portions of rods for rod 716 and rod 708 in FIG. 7.

As depicted, the rod shown in FIG. 8 has three flow channels at different heights and three ports connected to the three different flow channels to input the filaments of materials into hotend. In this example, the flow channels on the rod are shown by the three grooves shown on body of the rod as illustrated in front view 800 in FIG. 8A.

In this illustrative example, port A and flow channel of port A are located near the top of the rod, as illustrated in sectional view 802 in FIG. 8B. Port B and flow channel of port B are located below the port A and flow channel of the port A on the rod, as illustrated in section view 804 in FIG. 8C. In addition, port C and flow channel of port C are located below the port B and flow channel of the port B on the rod, as illustrated in section view 806 in FIG. 8D. In other words, the filaments of materials inputted by the inlets can enter the rod shown in FIG. 8 at three heights for microstructure control.

In this illustrative example, the filaments of materials enter port A, port B, and port C at different heights of the rod and flow along the rod to exit port A, port B, and port C at the bottom of rod, as illustrated in section view 808.

The flowchart and block diagram in the different depicted embodiments illustrate the architecture, functionality, and operation of some possible implementations of apparatus and methods in an illustrative embodiment. In this regard, each block in the flowcharts or block diagrams may represent a module, a segment, a function, and/or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

The term “couple” or “couples” is intended to mean either an indirect or direct connection. Thus, if a first device couples to a second device, that connection can be through a direct connection, or through an indirect connection via other devices and connections.

As used herein, the phrase “a number” means one or more. The phrase “at least one of”, when used with a list of items, means different combinations of one or more of the listed items may be used, and only one of each item in the list may be needed. As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the invention.

What is claimed is:

1. An apparatus for additive manufacturing, wherein the apparatus comprises:
a hotend for heating filaments for a number of materials; and
a nozzle coupled to the hotend, wherein the nozzle is configured to extrude the filaments for the number of materials onto a build surface, and wherein at least one of components of the apparatus is configured to rotate during extrusion of the filaments for the number of materials to mix the filaments for the number of materials according to a print plan, wherein the print plan defines locations and proportions of the number of materials in the extrusion of the filaments.

2. The apparatus of claim 1, wherein the print plan is utilized to locally control composition distribution throughout the local cross sections of the extrusions made using the filaments for the number of materials.

3. The apparatus of claim 1, wherein the number of materials comprise materials with different temperatures during the manufacturing process.

4. The apparatus of claim 1, wherein the number of materials comprise materials of different colors or appearances.

5. The apparatus of claim 1, wherein the number of materials comprise materials of different compositions.

6. The apparatus of claim 1, wherein the print plan is used to generate a set of program instructions for rotating at least one of the components of the apparatus.

7. The apparatus of claim 6, wherein the at least one of components of the apparatus comprise a rod for mixing the filaments for the number of materials according to the print plan.

8. The apparatus of claim 1, wherein the nozzle comprises a plurality of outlets with different shapes.

9. The apparatus of claim 1, wherein the filaments for the number of materials comprise catalysts that promote crystallization of melted polymers from the filaments for the number of materials.

10. The apparatus of claim 1, wherein the print plan is generated based on component ratio, filament ratio, steady and unsteady flow conditions, predicted filament flow through the hotend using a number of machine learning models, and extrusion aspect ratio for additive manufacturing using the filaments for the number of materials.

11. The apparatus of claim 1, wherein the print plan further comprises information associated with flow characteristics of the filaments for the number of materials to mix the filaments for the number of materials.

12. An apparatus for additive manufacturing, wherein the apparatus comprises:
a hotend for heating filaments for a number of materials;
a rod coupled to and positioned within the hotend, wherein the rod comprises a number of inlets positioned on the rod in a circular manner, and wherein the number of inlets are activated in a sequential manner to control mixing of filaments for the number of materials according to a print plan, wherein the print plan defines locations and proportions of the number of materials in the extrusion of the filaments; and
a nozzle coupled to the hotend, wherein the nozzle is configured to extrude the filaments for the number of materials onto a build surface.

13. The apparatus of claim 12, wherein the print plan is utilized to locally control composition distribution throughout the local cross sections of the extrusions made using the filaments for the number of materials.

14. The apparatus of claim 12, wherein the number of materials comprise materials with different temperatures during the manufacturing process.

15. The apparatus of claim 12, wherein the number of materials comprise materials of different colors or appearances.

16. The apparatus of claim 12, wherein the number of materials comprise materials of different compositions.

17. The apparatus of claim 12, wherein the filaments for the number of materials comprise catalysts that promote crystallization of melted polymers from the filaments for the number of materials.

18. An apparatus for additive manufacturing, wherein the apparatus comprises:
a hotend for heating filaments for a number of materials;
a number of inlets positioned in the apparatus, and wherein the number of inlets are activated in a sequential manner to control mixing of filaments for the number of materials according to a print plan, wherein the print plan defines locations and proportions of the number of materials in the extrusion of the filaments; and
a nozzle coupled to the hotend, wherein the nozzle is configured to extrude the filaments for the number of materials onto a build surface.

19. The apparatus of claim 18, wherein the print plan is utilized to locally control composition distribution throughout the local cross sections of the extrusions made using the filaments for the number of materials.

20. The apparatus of claim 18, wherein the number of materials comprise materials with different temperatures during the manufacturing process.
